(19) United States
(12) Patent Application Publication
(10) Pub. No.: US 2003/0075936 A1
(43) Pub. Date: Apr. 24, 2003

(54) Wafer blade equipped with piezoelectric sensors

(75) Inventors: Chun-Keng Hsu, Taoyuan (TW); Chun-Chih Lin, Taipei (TW); Chao-Lin Lee, Taipei (TW); Tin-Hau Kuo, Hsin-Chu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/040,104

(22) Filed: Oct. 19, 2001

(51) Int. Cl. B25J 15/00; B66C 1/00

(52) U.S. Cl. 294/1.1; 294/907

(57) ABSTRACT

A wafer blade for picking up or delivering wafers from or to a wafer cassette or a process tool is described. The wafer blade carries a wafer on a top surface of the blade, and is capable of detecting any undesirable contact with wafers on a bottom surface of the blade. The wafer blade is constructed by a blade body of generally elongated shape that has a top surface and a bottom surface parallel to each other, and a strain sensor such as a piezoelectric thin film sensor mounted on and at least partially cover the bottom surface of the blade body for detecting any contact with the wafer and for sending an alarm signal to a central process controller when such contact or scratch of a wafer has occurred.

### FIELD OF THE INVENTION

The present invention generally relates to a wafer blade for picking up wafers during semiconductor processing and more particularly, relates to a wafer blade for picking up wafers on a top surface of the blade and for detecting any undesirable contact with wafers on a bottom surface of the blade.

### BACKGROUND OF THE INVENTION

In the fabrication of integration circuit devices, an electronic substrate, such as a wafer must be processed in numerous processing steps, i.e., as many as several hundred processing steps. During each of the processing steps, a silicon wafer must be transported in and out of a specific process machine such as an etcher, a physical vapor deposition chamber, a chemical vapor deposition chamber, etc. Between the processing steps, a preprocessed wafer is stored in a storage container called a wafer cassette. The wafer cassette is then stored in a container known as a pod to prevent contamination.

The wafer cassette is a device that is normally molded of a plastic material which can be used to store a large number of wafers in a horizontal position. In order to maximize the number of wafers that can be stored in a cassette, the wafers are positioned relatively close to each other. For instance, a pitch distance between the wafers is approximately 6-7 mm in a normal cassette. The wafers, when stored in the cassette are supported on their edges by molded-in supports (or dividers) on the interior walls of the cassette.

To load or unload a wafer into or out of a process machine or a wafer cassette, a device known as a wafer transporting blade, or a wafer blade that is normally formed in a rectangular shape is used. For instance, for loading and unloading an 8 inch wafer which has a diameter of 200 mm, a wafer blade that is 150 mm long and 70 mm wide is normally used. The wafer blade is equipped with a handle portion for connecting to a robot arm. A typical processing equipment that utilizes a wafer blade for loading or unloading wafers is one such as that manufactured by applied Materials Corp. of Santa Clara, Calif. In a P5000® main frame etcher, load lock chambers equipped with wafer blades are used to transport wafers into and out of various etch chambers. The chambers are used for etching polysilicon, oxide or metal layers.

A wafer blade, when first installed, is in a perfectly flat and level condition and there is no warpage or bend in the blade. However, after repeated usage, the blade may become warped or otherwise deformed which may cause serious processing problems. When a blade, which is normally about 1˜2 mm thick, is used to pick up a wafer, which is normally 0.8 mm, from a wafer cassette that has only a 3˜4 mm clearance from its neighboring wafers, a warpage or bend in the wafer blade and cassette not at home position or bad robot teaching, may cause severe damage to the wafers, i.e., scratching in the surface or even breakage of the wafers. Since a wafer blade is controlled by a robotic arm which is programmed assuming that the blade is perfectly flat and leveled, even a small deviation from flatness or levelness may cause severe damage to the wafers. A reliable method for detecting the flatness of a wafer transporting blade is therefore an important step in wafer processing.

A typical wafer blade 10 formed in a fork shape is shown in FIG. 1A. The wafer blade 10 is constructed with a body portion 12 and two fork portions 14 having reduced dimension. The body portion 12 is provided with mounting holes 16 for connecting to a robot arm (not shown). The wafer blade 10 is formed of a thin metallic or ceramic material with a thickness between about 1 mm and about 2 mm, and preferably at about 1.5 mm.

FIGS. 1B and 1C illustrate another typical wafer blade 30 used in transporting 200 mm wafers. The wafer blade 30 generally has a dimension of 150 mm length and 70 mm width. The wafer blade 30 is constructed of a blade body 32 of generally elongated rectangular shape and formed of a rigid metallic material such as aluminum or stainless steel. At a base portion 34 of the blade body 32, mounting means 36 which are screw holes is provided for attaching to a robot arm (not shown). FIG. 4 shows the back side surface 38 of the blade body 32 which further contains a vacuum passageway 42, i.e., a channel formed in the blade body 32 and sealed by a cover 44. At a base portion 34 of the blade body 32, the vacuum passageway 42 is in fluid communication with an external vacuum source (not shown) through a vacuum inlet 46. At the front portion 48 of the blade body 32, the vacuum passageway 42 is in fluid communication with a recessed vacuum port 50 through a vacuum opening 52. A side view of the blade body 32 is shown in FIG. 1C. There is still another type of wafer blade with the same shape as FIG. 1B, which is made of ceramic or quarts without vacuum passageway.

The operation of a typical wafer blade 10 or 32 is illustrated in FIGS. 2A˜2C. The wafer blade 10 or 30 is operated by a robot arm 40 for positioning a wafer 20 into a wafer cassette (not shown). Other wafers 22 are already positioned in the wafer cassette. After the wafer blade 10,30 is fully extended into the wafer cassette with the wafer 20 positioned on top, as shown in FIG. 2B, the wafer blade 10,30 is withdrawn by the robot arm 40. When there is any warpage or bend in the wafer blade 10,30, the withdrawal of a 1.5 mm thick wafer blade from the wafer cassette where there is only a 3˜4 mm clearance between the wafers becomes an extremely difficult task if the touching or scratching of the wafer 22 below is to be completely avoided. As shown in FIG. 2C, a slightly warped wafer blade 10,30 is likely to touch the wafer 22 below during the blade withdrawal process and thus wafer 22 can be severely scratched. This occurs either with a warped wafer blade, error cassette position, or when the robot arm is inaccurately setup. The scratching of a wafer occurs not only in a wafer cassette, but also in a process tool such as a furnace boat.

The scratching of the bottom wafer, if not detected, can cause a defective wafer being further processed thus resulting in defective IC devices fabricated. The scratching of wafers can occur when the wafer blade is fabricated of either metal or ceramic material due to the small pitch available between the wafers.

It is therefore an object of the present invention to provide a wafer blade for picking up wafers from a wafer cassette or a process tool that does not have the drawbacks or shortcomings of the conventional wafer blades.

It is another object of the present invention to provide a wafer blade for picking up wafers from a wafer cassette or a process tool that is capable of triggering an alarm when the blade scratches a wafer on its bottom surface.

It is a further object of the present invention to provide a wafer blade for picking up or delivering wafers to or from a wafer cassette or a process tool which is equipped with a strain sensor mounted on a bottom surface of the blade.

It is another further object of the present invention to provide a wafer blade for picking up or delivering wafers from or to a wafer cassette or a process tool wherein the blade is equipped with a piezoelectric sensor on its bottom surface.

It is still another object of the present invention to provide a wafer pick-up system that includes a wafer blade, a strain sensor mounted on a bottom surface of the blade, and an alarm device for receiving a signal from the strain sensor when a strain is detected on the bottom surface of the blade.

### SUMMARY OF THE INVENTION

In accordance with the present invention, a wafer blade for picking up or delivering wafers from or to a wafer cassette or a process tool that is capable of detecting any undesirable contact with wafers on a bottom surface of the blade is provided.

In a preferred embodiment, a wafer blade for picking up or delivering wafers on a top surface of the blade and for detecting any undesirable contact with wafers by a bottom surface of the blade is provided which includes a blade body of generally elongated shape that has a top surface and a bottom surface parallel to each other; and a strain sensor mounted on and at least partially cover the bottom surface of the blade body.

In the wafer blade for picking up or delivering wafers, the strain sensor may be a piezoelectric sensing device, or may be a sensor that is sensitive to at least 1 μm strain. The blade body may be formed in the shape of a fork, or may be formed in the shape of a rectangle. The blade body may be formed of metal or ceramic. The strain sensor may be provided in the shape of a thin film.

The present invention is further directed to a wafer body for picking up or delivering wafers that includes a blade body of fork shape that has a top surface for picking up wafers and a bottom surface; and a piezoelectric sensor mounted on the bottom surface for detecting any undesirable touching with wafers.

In the wafer blade for picking up wafers, the piezoelectric sensor may be a thin film sensor, and may be capable of detecting a small strain imposed on the sensor. The blade body may be fabricated of a metal or a ceramic that has the rigidity of at least that of aluminum. The piezoelectric sensor covers substantially the entire bottom surface of the blade body, or covers only partially the bottom surface of the blade body.

The present invention is still further directed to a wafer pick-up and delivering system that includes a wafer blade having a blade body of generally elongated shape, the blade body has a top surface and a bottom surface; a strain sensor mounted on a bottom surface of the blade body; and an alarm device for receiving a signal from the strain sensor when a strain is detected and for sending an alarm signal to alert an operator.

In the wafer pick-up and delivery system, the blade body may have a fork shape or a rectangular shape. The alarm device may receive an electrical current from the strain sensor when a strain is detected on the sensor. The alarm device sends a signal to a process controller when a strain is detected by the sensor. The signal may be a warning light or a siren. The strain sensor may be a piezoelectric thin film sensor.

### BRIEF DESCRIPTION OF THE DRAWINGS

These and other objects, features and advantages of the present invention will become apparent from the following detailed description and the appended drawings in which:

FIG. 1A is a plane view of a typical wafer blade in a fork shape.

FIG. 1B is a plane view of a typical wafer blade in a rectangular shape.

FIG. 1C is a cross-sectional view of the rectangular blade of FIG. 1B.

FIG. 2A is a graph illustrating a typical wafer blade being used to deliver a wafer into a wafer cassette or a process tool.

FIG. 2B is a graph illustrating a typical wafer blade that positions a wafer into the wafer cassette or process tool.

FIG. 2C is a graph illustrating the wafer blade scratches a bottom wafer during the withdrawal process of the blade.

FIG. 3 is a cross-sectional view of a present invention wafer blade equipped with a piezoelectric sensor on a bottom surface of the blade.

FIG. 4 is a graph illustrating the present invention wafer blade mounted on a robot arm and connected to an alarm panel.

FIG. 5A is a graph illustrating the operation of the present invention wafer blade in delivering a wafer into a wafer cassette or a process tool.

FIG. 5B is a graph illustrating the present invention wafer blade which positions a wafer in the wafer cassette or process tool and moves downwardly for withdrawal of the blade.

FIG. 5C is a graph illustrating the present invention wafer blade that touches a bottom wafer during the withdrawal of the blade and triggers an alarm panel.

### DETAILED DESCRIPTION OF THE PREFERRED EMBODIMENT

The present invention discloses a wafer blade for use in picking up or delivering wafers from or to a wafer cassette or a process tool, such as a furnace boat. The present invention wafer blade holds a wafer on a top surface of the blade, and is equipped with a strain sensor on a bottom surface of the blade capable of detecting any undesirable contact with a wafer below the wafer that is being picked up or delivered.

The present invention wafer blade is constructed by a blade body that is generally of elongated shape, i.e., either in a fork shape or in a rectangular shape, that has a top surface and a bottom surface. The top surface and the bottom surface are generally parallel to each other defining a small thickness of the blade at between about 1.5 mm and about 3 mm. The word “about” used in this writing indicates a range of values that is ±10% from the average value given.

The strain sensor utilized by the present invention can be any type of sensor that is provided in a thin film configuration. The strain sensor should be sensitive to very small strains, such as strains as small as 1 μm. One of such suitable strain sensors to be utilized by the present invention wafer blade may be a piezoelectric thin film sensor. When the piezoelectric thin film sensor makes a mechanical contact with a surface, an electric field is produced and a signal in the form of an electrical current can be amplified and sent to an alarm panel.

The principle of the functioning of a piezoelectric element is that when such element is stressed mechanically by a force, i.e., touched by a wafer surface, the piezoelectric element generates an electric current. A piezoelectric element can be used both as a sensor and as an actuator. The relationship between applied forces and the resultant responses depends on the piezoelectric properties of the element, the size and shape of the element, and the direction of the electrical and mechanical excitation. A piezoelectric element is frequently fabricated of a ceramic material, or a piezoceramic. Piezoceramic elements are capable of generating very high voltages, thus they can be used in solid state devices for their high efficiency. For instance, in the present invention application of a piezoelectric element or a piezoelectric thin film sensor on a bottom surface of a wafer blade, any minute contact with a wafer can be detected and an alarm can be sent to an alarm panel located in a central process controller.

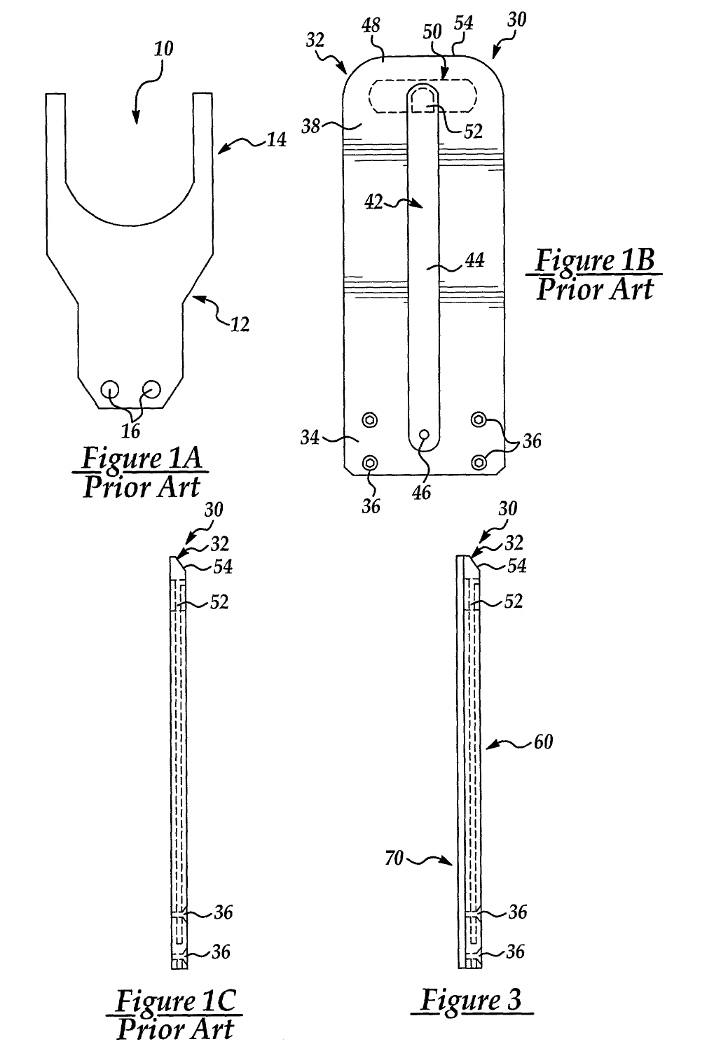

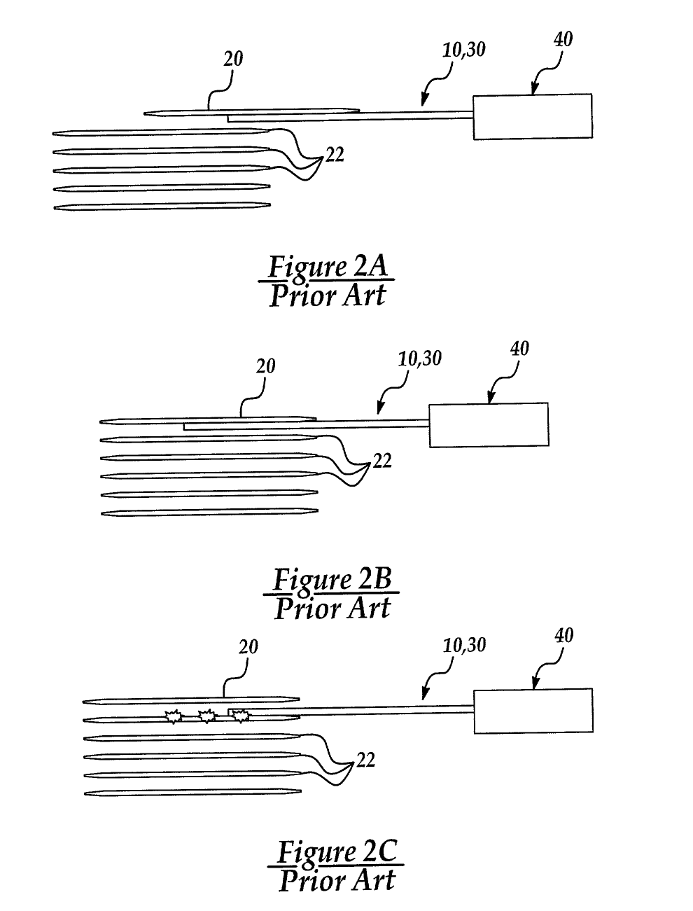

Referring now to FIG. 3 wherein a present invention wafer blade 60 that is equipped with a strain sensor 70 on a bottom surface 62 is shown. The piezoelectric thin film sensor 70 can be used to either cover the entire bottom surface 62 of the wafer blade 60, or cover only partially the bottom surface 62, depending on the specific application. In a preferred embodiment, the piezoelectric thin film sensor 70 is advantageously assembled to the bottom surface 62 of the wafer blade 60 by adhesive means. It should be noted that while in FIG. 3, only the application of a piezoelectric thin film sensor 70 on a wafer blade 60 of the rectangular configuration is shown, the present invention wafer blade can be similarly formed of the fork-type shown in FIG. 1A.

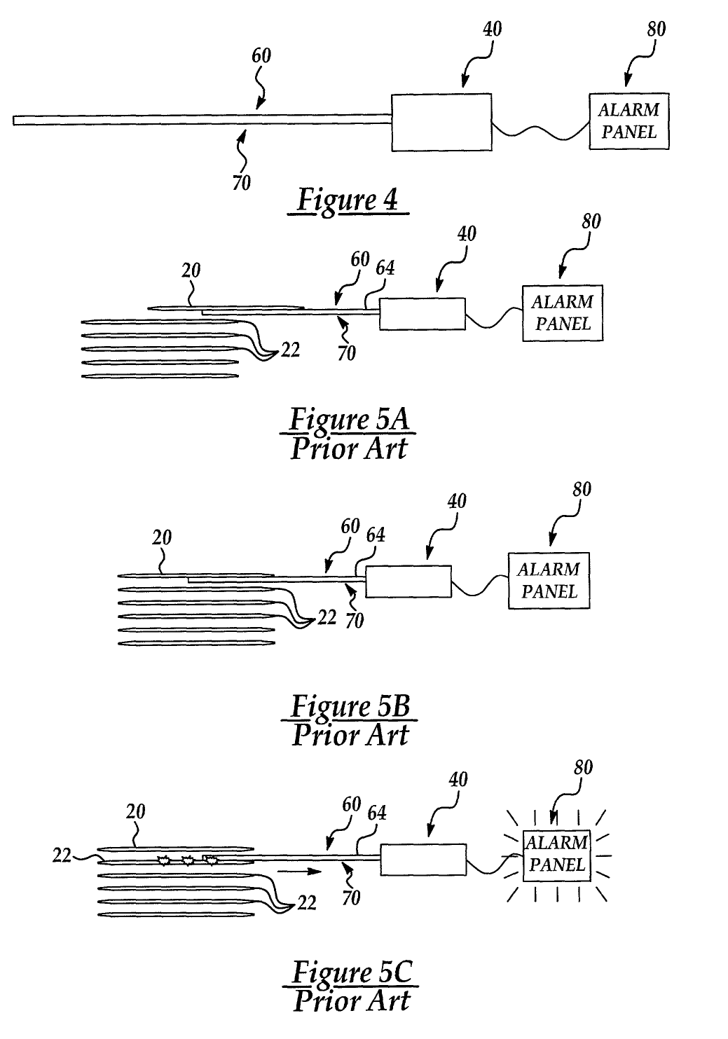

The sensitivity of the piezoelectric thin film sensor 70 must be such that any minute mechanical contact with a wafer below the wafer blade during operation can be detected. For instance, a strain caused by the contact force as small as 1 μm should be detected and an electric field amplified to produce an electrical signal for the alarm panel 80 shown in FIG. 4.

FIG. 4 illustrates the electrical connection of the present invention wafer blade 60 that is equipped with the piezoelectric thin film sensor 70. The robot arm 40 is further equipped with hybrid signal-processing components for receiving a signal from the piezoelectric thin film sensor 70 (when the sensor touches a bottom wafer), and then amplifying a signal received for sending to the alarm panel 80.

A step-by-step operation of the present invention wafer blade 60 is further illustrated in FIGS. 5A˜5C. As shown in FIG. 5A, in the first step, the robot arm 40 extends the wafer blade 60 which carries a wafer 20 on a top surface 64. After the wafer 20 is positioned inside a wafer cassette or a process tool (not shown) at its storage position, shown in FIG. 5B, the wafer blade 60 is moved downwardly by a small displacement to unload the wafer 20 from its top surface 64. After the wafer blade 60 is lowered, the robot arm 40 withdraws the blade 60 outwardly from the wafer cassette or the process tool (not shown). At this point, when the bottom surface of the piezoelectric thin film sensor 70 touches the wafer 22 positioned below wafer 20, the piezoelectric thin film sensor 70 senses the strain produced and generates an electric field, which is then amplified by the hybrid signal-processing components incorporated into the robot arm 40 into an electrical signal sufficient to trigger the alarm panel 80. The alarm panel 80 can be advantageously formed as part of a central process control unit (not shown). The touching of the wafer blade 60 with the bottom wafer 22 may be caused by either a warpage in the blade itself or by a bad (inaccurate) teaching of the robot arm during the robot set-up.

The present invention wafer blade for picking up or delivering wafers from or to a wafer cassette or a process tool that is capable of detecting any undesirable contact with wafers on a bottom surface of the blade has therefore been amply described in the above descriptions and in the appended drawings of FIGS. 3˜5C.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A wafer blade for picking up wafers on a top surface of the blade and for detecting any undesirable contact with wafers on a bottom surface of the blade comprising:
a blade body of generally elongated shape having a top surface and a bottom surface parallel to each other; and
a strain sensor mounted on and at least partially covers said bottom surface of the blade body.

2. A wafer blade for picking up wafers on a top surface of the blade according to claim 1, wherein said strain sensor is a piezoelectric sensing device.

3. A wafer blade for picking up wafers on a top surface of the blade according to claim 1, wherein said strain sensor is sensitive to at least 1 μm strain.

4. A wafer blade for picking up wafers on a top surface of the blade according to claim 1, wherein said blade body is formed in the shape of a fork.

5. A wafer blade for picking up wafers on a top surface of the blade according to claim 1, wherein said blade body is formed in the shape of a rectangle.

6. A wafer blade for picking up wafers on a top surface of the blade according to claim 1, wherein said blade body is formed of metal or ceramic.

7. A wafer blade for picking up wafers on a top surface of the blade according to claim 1, wherein said strain sensor is formed in the shape of a thin film.

8. A wafer blade for picking up wafers comprising:
a blade body of fork shape having a top surface for picking up wafers and a bottom surface; and
a piezoelectric sensor mounted on said bottom surface for detecting any undesirable touching with wafers.

9. A wafer blade for picking up wafers according to claim 8, wherein said piezoelectric sensor is a thin film sensor.

10. A wafer blade for picking up wafers according to claim 8, wherein said piezoelectric sensor is capable of detecting a strain imposed on said sensor.

11. A wafer blade for picking up wafers according to claim 8, wherein said blade body is fabricated of a metal or a ceramic that has the rigidity at least that of aluminum.

12. A wafer blade for picking up wafers according to claim 8, wherein said piezoelectric sensor covers substantially the entire surface of said blade body.

13. A wafer blade for picking up wafers according to claim 8, wherein said piezoelectric sensor only covers partially the bottom surface of said blade body.

14. A wafer pick-up system comprising:
a wafer blade having a blade body of generally elongated shape; said blade body having a top surface and a bottom surface;
a strain sensor mounted on said bottom surface of the blade body; and
an alarm device for receiving a signal from said strain sensor when a strain is detected and for sending an alarm signal to alert an operator.

15. A wafer pick-up system according to claim 14, wherein said blade body has a fork shape.

16. A wafer pick-up system according to claim 14, wherein said blade body has a rectangular shape.

17. A wafer pick-up system according to claim 14, wherein said alarm device receives an electrical current from said strain sensor when a strain is detected.

18. A wafer pick-up system according to claim 14, wherein said alarm device sends a signal to a process controller when a strain is detected by the strain sensor.

19. A wafer pick-up system according to claim 14, wherein said alarm signal is a warning light.

20. A wafer pick-up system according to claim 14, wherein said strain sensor is a piezoelectric thin film sensor.
